(19) United States
(12) Patent Application Publication
(10) Pub. No.: US 2024/0419926 A1
(43) Pub. Date: Dec. 19, 2024

(54) DEVICE AND METHOD FOR PROCESSING VOICES OF SPEAKERS

(71) Applicant: AMOSENSE CO., LTD., Cheonan-si, Chungcheongnam-do (KR)

(72) Inventor: Jungmin KIM, Cheonan-si (KR)

(73) Assignee: AMOSENSE CO., LTD., Cheonan-si, Chungcheongnam-do (KR)

(21) Appl. No.: 18/580,554

(22) PCT Filed: Jul. 14, 2022
(86) PCT No.: PCT/KR2022/010276

§ 371 Date: Jan. 18, 2024

(30) Foreign Application Priority Data
Jul. 19, 2021 (KR) 10-2021-0094265

(51) Int. Cl. G06F 40/58; G10L 17/02; G10L 21/028

(52) U.S. Cl. CPC G06F 40/58; G10L 17/02; G10L 21/028

(57) ABSTRACT

A voice processing device for generating translation results for voices of speakers is disclosed. The voice processing device comprises: a microphone for generating voice signals associated with voices of speakers in response to the voices of the speakers; a memory for storing location-language information indicating languages corresponding to sound source locations of the voices of the speakers; and a processor which uses the voice signals and the location-language information so as to generate translation results obtained by translating the languages of the voices of each speaker, and which uses the translation results so as to generate translation conference minutes including the voice contents of each speaker expressed in different languages.

### TECHNICAL FIELD

Embodiments of the present disclosure relate to a device and a method for processing voices of speakers.

### BACKGROUND ART

A microphone is a device for recognizing voices and converting the voices into voice signals which are electrical signals. When the microphone is disposed in a space in which a plurality of speakers are positioned, such as conference rooms or classrooms, the microphone receives all voices coming from the plurality of speakers and generates voice signals related to the voices of the plurality of speakers.

When the plurality of speakers speaks at the same time, it is necessary to separate the voice signals representing only the voices of individual speakers. In addition, when the plurality of speakers pronounce in different languages, in order to easily translate the voices of the plurality of speakers, original languages (i.e., source languages) of the voices of the plurality of speakers should be identified, and when the language of the corresponding voice is identified by using only the characteristics of the voices, there is a problem in that it takes much time and many resources are required.

### SUMMARY OF INVENTION

### Technical Problem

The present disclosure is directed to providing a voice processing device and method, which may identify positions of speakers using voice signals of the speakers and separate and recognize voice signals for each speaker.

The present disclosure is also directed to providing a voice processing device and method, which may determine a position of each of speakers from voices of the speakers, determine a current language of each of the speakers according to the determined position, and generate translation results in which the current language of the voice of each of the speakers is translated into different languages according to the determined current language.

The present disclosure is also directed to providing a voice processing device and method, which may generate translated minutes of meeting including a voice content of each of speakers, which are expressed in different languages using translation results obtained by translating a current language of a voice of each of the speakers into different languages.

### Solution to Problem

A voice processing device according to embodiments of the present disclosure is configured to generate translation results for voices of speakers, and the voice processing device includes a microphone configured to generate voice signals associated with the voices of the speakers in response to the voices of the speakers, a memory configured to store position-language information representing languages corresponding to sound source positions of the voices of the speakers, and a processor configured to generate translation results obtained by translating the language of the voice of each of the speakers using the voice signal and the position-language information and generate translated minutes of meeting including a voice content of each of the speakers expressed in different languages using the translation results.

### Advantageous Effects of Invention

According to the voice processing device and method according to the embodiments of the present disclosure, it is possible to identify the positions of the speakers using the voice signals of the speakers and separate and recognize the voice signals for each speaker.

According to the voice processing device and method according to the embodiments of the present disclosure, it is possible to determine the position of each of the speakers from the voices of the speakers, determine the current language of each of the speakers according to the determined position, and generate the translation results in which the current language of the voice of each of the speakers is translated into different languages according to the determined current language.

According to the voice processing device and method according to the embodiments of the present disclosure, it is possible to generate the translated minutes of meeting including the voice content of each of the speakers, which are expressed in different languages using translation results obtained by translating a current language of a voice of each of the speakers into different languages.

### BRIEF DESCRIPTION OF DRAWINGS

FIG. 1 is a view illustrating a voice processing system according to embodiments of the present disclosure.

FIG. 2 is a view illustrating a voice processing device according to the embodiments of the present disclosure.

FIG. 3 is a view for describing an operation of the voice processing device according to the embodiments of the present disclosure.

FIG. 4 is a flowchart illustrating a voice separation method performed by the voice processing device according to the embodiments of the present disclosure.

FIG. 5 is a view for describing a translation function of the voice processing device according to the embodiments of the present disclosure.

FIG. 6 is a view for describing a translation function of the voice processing device according to the embodiments of the present disclosure.

FIG. 7 is a flowchart illustrating a method of generating translation results by the voice processing device according to the embodiments of the present disclosure.

FIG. 8 is a view for describing an operation of the voice processing device according to the embodiments of the present disclosure.

### DESCRIPTION OF EMBODIMENTS

Hereinafter, embodiments of the present disclosure will be described with reference to the accompanying drawings.

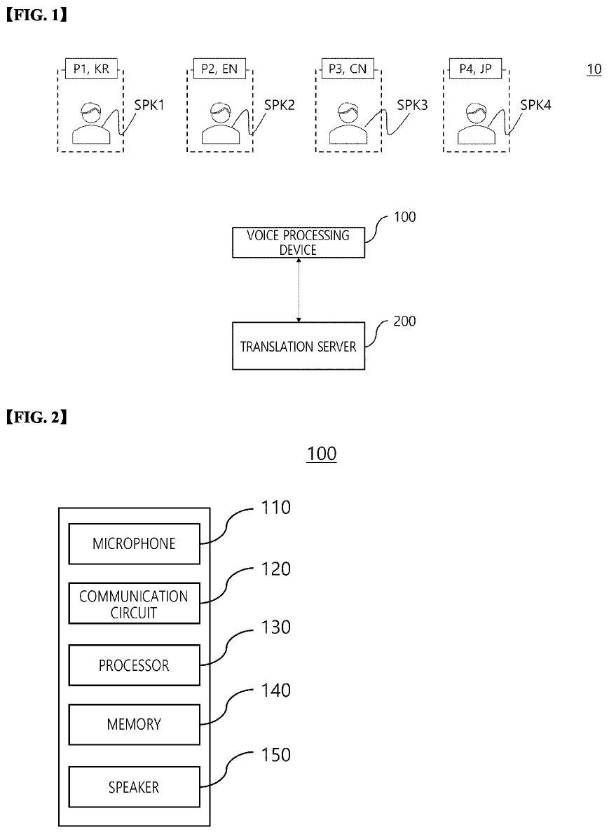

FIG. 1 is a view illustrating a voice processing system according to embodiments of the present disclosure. Referring to FIG. 1, a voice processing system 10 according to embodiments of the present disclosure may include a voice processing device 100 and a translation server 200.

The voice processing system 10 may separate voices of speakers SPK1 to SPK4 and provide translation for the separated voices of each of the speakers SPK1 to SPK4.

The speakers SPK1 to SPK4 may be positioned in a space (e.g., a conference room, a vehicle, or a classroom) to pronounce their voices. For example, the first speaker SPK1 positioned at a first position P1 may pronounce a voice in a first language (e.g., Korean (KR)), the second speaker SPK2 positioned at a second position P2 may pronounce a voice in a second language (e.g., English (EN)), the third speaker SPK3 positioned at a third position P3 may pronounce a voice in a third language (e.g., Japanese (JP)), and the fourth speaker SPK4 positioned at a fourth position P4 may pronounce a voice in a fourth language (e.g., Chinese (CN)).

The voice processing device 100 may generate voice signals associated with the voices of the speakers SPK1 to SPK4 in response to the voice of each of the speakers SPK1 to SPK4. The voice signal is a signal associated with voices pronounced for a specific time and may be a signal representing the voices of a plurality of speakers.

The voice processing device 100 may separate and recognize the voices of the speakers SPK1 to SPK4 for each of the speakers SPK1 to SPK4. When the plurality of speakers SPK1 to SPK4 pronounce simultaneously, the voice includes the voices of all speakers SPK1 to SPK4. In order to accurately process the voice of each of the speakers SPK1 to SPK4, it is necessary to separate the voice of only each of the speakers SPK1 to SPK4 from the voice that includes all voices of the plurality of speakers SPK1 to SPK4.

The voice processing device 100 according to the embodiments may determine a sound source position of each of the voices of the speakers SPK1 to SPK4 using the voice signals associated with the voices of the speakers SPK1 to SPK4 and perform sound source separation based on the sound source position, and thus extract (or generate) the separation voice signal associated with the voice of each of the speakers SPK1 to SPK4 from the voice signal.

In other words, the voice processing device 100 may generate the separation voice signal associated with the voices of the speakers SPK1 to SPK4 positioned at the positions P1 to P4 based on the sound source positions of the voices (i.e., positions of the speakers). According to the embodiments, the voice processing device 100 may classify components of the voice signal for each of the positions P1 to P4 and generate the separation voice signal associated with the voice pronounced at each of the positions P1 to P4 using the classified components corresponding to each of the positions P1 to P4.

For example, the voice processing device 100 may generate a first separation voice signal associated with the voice of the first speaker SPK1 pronounced at the first position P1 based on the voice signal. In this case, the first separation voice signal may be a voice signal with the highest correlation with the voice of the first speaker SPK1 among the voices of the speakers SPK1 to SPK4. In other words, among voice components included in the first separation voice signal, a proportion of a voice component of the first speaker SPK1 may be the highest.

In addition, the voice processing device 100 according to the embodiments of the present disclosure may determine the positions of the speakers SPK1 to SPK4 from the voice signals, determine current languages (i.e., source languages) of the voices of the speakers SPK1 to SPK4 based on the positions of the speakers SPK1 to SPK4 determined from the voice signals, and generate translation results obtained by translating the languages of the voices of the speakers SPK1 to SPK4 into different languages.

Generally, in order to translate a voice, information about a current language of the corresponding voice is needed. However, there is a problem in that when a voice is interpreted and a current language of the corresponding voice is identified, many resources are required. On the other hand, since the voice processing device 100 according to the embodiments of the present disclosure may determine the languages (i.e., the source languages) of the voices of the speakers SPK1 to SPK4 through the positions of the speakers SPK1 to SPK4, there is no need to interpret the voices of the speakers SPK1 to SPK4 and determine the language, and thus it is possible to reduce the time and resources required for translation.

In the present specification, when the voice processing device 100 generates the translation results, it means that the voice processing device 100 not only generates the translation results obtained by translating the language of the voice, but also transmits a translation request to an external translation server and receives the translation results generated from a translation program executed by an external server from the translation server according to the execution of the program stored in the voice processing device 100.

According to the embodiments, the voice processing device 100 may output the translation result for each of the voices. The translation result may be text data or a voice signal associated with the voice of each of the speakers SPK1 to SPK4, which is expressed in target languages.

The translation server 200 may provide translation for languages. According to the embodiments, the translation server 200 may receive the voice signals associated with the voices of the speakers SPK1 to SPK4 from the voice processing device 100 and provide the translation results in which the voices of the speakers SPK1 to SPK4 are translated into different languages to the voice processing device 100.

The translation server 200 may perform translation work through its own calculation and provide translation results, but is not limited thereto. For example, the translation server 200 may receive the translation results from the outside and provide the input translation results back to the voice processing device 100.

Although the voice processing device 100 and the translation server 200 are illustrated separately in FIG. 1, the voice processing device 100 may include the translation server 200 according to the embodiments. This may mean that the voice processing device 100 stores a translation program executed by using a processor of the voice processing device 100.

FIG. 2 is a view illustrating a voice processing device according to the embodiments of the present disclosure. Referring to FIG. 2, the voice processing device 100 may include a microphone 110, a communication circuit 120, a processor 130, and a memory 140. According to the embodiments, the voice processing device 100 may further include a speaker 150.

The microphone 110 may generate a voice signal in response to a generated voice. According to the embodiments, the microphone 110 may detect air vibration caused by a voice and generate a voice signal, which is an electrical signal corresponding to the vibration, according to a result of the detection. For example, the microphone 110 may receive the voices of the speakers SPK1 to SPK4 respectively positioned at the positions P1 to P4 and convert the voices of the speakers SPK1 to SPK4 into voice signals which are electrical signals.

According to the embodiments, the microphone 110 may be provided as a plurality of microphones, and each of the plurality of microphones 110 may generate the voice signal in response to the voice. In this case, since a position of each of the plurality of microphones 110 may differ from each other, the voice signals generated from the microphones 110 may have a phase difference (or a time delay).

Meanwhile, in the present specification, although it is described that the voice processing device 100 includes the microphone 110 and directly generates the voice signals associated with the voices of the speakers SPK1 to SPK4 using the microphone 110, according to the embodiments, the microphone may be configured externally by being separated from the voice processing device 100, and the voice processing device 100 may receive the voice signals from the microphone configured separately and process or use the received voice signals. For example, the voice processing device 100 may generate a separation voice signal from the voice signal received from the separated microphone.

However, for convenience of description, unless otherwise stated, the description will be made assuming that the voice processing device 100 includes the microphone 110.

The communication circuit 120 may exchange data with an external device according to a wireless communication method. According to the embodiments, the communication circuit 120 may exchange data with the external device using radio waves of various frequencies. For example, the communication circuit 120 may exchange data with the external device according to at least one of short-range wireless communication, mid-range wireless communication, and long-distance wireless communication.

The processor 130 may control the overall operation of the voice processing device 100. According to the embodiments, the processor 130 may include a processor with a calculation processing function. For example, the processor 130 may be a central processing unit (CPU), a micro controller unit (MCU), a graphics processing unit (GPU), a digital signal processor (DSP), an analog to digital converter (ADC converter), or a digital to analog converter (DAC converter), but is not limited thereto.

Unless otherwise stated, the operation of the voice processing device 100 described in the present specification may be understood as the operation of the processor 130.

The processor 130 may process the voice signals generated by the microphone 110. For example, the processor 130 may convert an analog type voice signal generated by the microphone 110 into a digital type voice signal and process the converted digital type voice signal. In this case, since the type (analog or digital) of signal changes, the digital type voice signal and the analog type voice signal will be used interchangeably in the description of embodiments of the present invention.

According to the embodiments, the processor 130 may extract (or generate) the separation voice signal associated with the voice of each of the speakers SPK1 to SPK4 using the voice signal generated by the microphone 110. According to the embodiments, the processor 130 may generate the separation voice signals associated with the voices of the speakers SPK1 to SPK4 positioned at the positions P1 to P4, respectively. The separation voice signal may be in the form of voice data or text data.

The processor 130 may determine sound source positions of the voices (i.e., the positions of the speakers SPK1 to SPK4) using a time delay (or a phase delay) between the voice signals. For example, the processor 130 may determine relative positions of the sound sources (i.e., the speakers SPK1 to SPK4) with respect to the voice processing device 100.

The processor 130 may generate the separation voice signals associated with the voices of each of the speakers SPK1 to SPK4 based on the determined sound source position. According to the embodiments, the processor 130 may classify components of the voice signal for each of the positions P1 to P4 and generate the separation voice signal associated with the voice pronounced at each of the positions P1 to P4 using the classified components corresponding to each of the positions P1 to P4. For example, the processor 130 may generate a first separation voice signal associated with the voice of the first speaker SPK1 based on the sound source positions of the voices.

According to the embodiments, the processor 130 may match sound source position information representing the determined sound source position with the separation voice signal and store a result of matching. For example, the processor 130 may match the first separation voice signal associated with the voice of the first speaker SPK1 with first sound source position information representing the sound source position of the voice of the first speaker SPK1 and store a result of matching in the memory 140. In other words, since the position of the sound source corresponds to the position of each of the speakers SPK1 to SPK4, sound source position information may serve as speaker position information for identifying the position of each of the speakers SPK1 to SPK4.

The processor 130 may determine the languages (i.e., the source languages) of the voices of the speakers SPK1 to SPK4 using the sound source position information. According to the embodiments, the processor 130 may determine the language of each voice by determining the sound source position information from the voices of the speakers SPK1 to SPK4 and determining position-language information corresponding to the determined sound source position information. In this case, the position-language information is information representing the languages of the speakers SPK1 to SPK4 at each position and may be matched to each position in advance and stored in the memory 140. Detailed description thereof will be made below.

The processor 130 may transmit the separation voice signal associated with the voice of each of the speakers SPK1 to SPK4 and information representing the language of the corresponding voice to the translation server 200 using the communication circuit 120. According to the embodiments, the processor 130 may generate a control command for transmitting the separation voice signal and the information representing the language of the voice to the translation server 200.

The translation server 200 may generate the translation result obtained by translating the language of the voice of the speaker using the separation voice signal.

Alternatively, according to the embodiments, the processor 130 may translate the voices of the speakers SPK1 to SPK4 using the separation voice signal associated with the voice of each of the speakers SPK1 to SPK4 and the position-language information and generate the translation results. For example, the processor 130 may generate the translation results obtained by translating the voice of the speaker into the target languages by executing the translation program and providing the translation program with the separation voice signal associated with the voice of the speaker and the position-language information as an input.

The translation result may be text data or a voice signal associated with the voice of each of the speakers SPK1 to SPK4, which is expressed in the target languages.

According to the embodiments, the processor 130 may generate minutes of meeting written in the languages of the speakers SPK1 to SPK4 using the translation results. For example, the processor 130 may generate the text data for the voice of each of the speakers SPK1 to SPK4 using the separation voice signal and generate the minutes of meeting by arranging or listing the text data of each speaker according to a time point at which the voice is recognized.

An operation of the processor 130 or the voice processing device 100 described in the specification may be implemented in the form of a program executable by a computing device. For example, the processor 130 may execute an application stored in the memory 140 and perform operations corresponding to commands instructing specific operations depending on the execution of the application.

The memory 140 may store data necessary for the operation of the voice processing device 100. For example, the memory 140 may include at least one of a non-volatile memory and a volatile memory.

According to the embodiments, the memory 140 may store an identifier corresponding to each of the positions P1 to P4 in space. The identifier may be data for distinguishing the positions P1 to P4. Since each of the speakers SPK1 to SPK4 is positioned in each of the positions P1 to P4, each of the speakers SPK1 to SPK4 may be distinguished by using the identifiers corresponding to the positions P1 to P4. For example, a first identifier indicating the first position P1 may represent the first speaker SPK1. From this perspective, the identifier corresponding to each of the positions P1 to P4 in space may serve as a speaker identifier for identifying each of the speakers SPK1 to SPK4.

The identifier may be input through an input device (e.g., a touch pad) of the voice processing device 100.

According to the embodiments, the memory 140 may store the sound source position information associated with the position of each of the speakers SPK1 to SPK4 and the separation voice signal associated with the voice of each of the speakers SPK1 to SPK4.

In addition, the memory 140 may store the position-language information representing the languages of the voices of the speakers SPK1 to SPK4. According to the embodiments, the position-language information may be matched to each position in advance and stored in the memory 140. Detailed description thereof will be made below.

The speaker 150 may vibrate under the control of the processor 130, and a voice may be generated according to the vibration. According to the embodiments, the speaker 150 may reproduce the voice associated with the voice signal by generating the vibration corresponding to the voice signal.

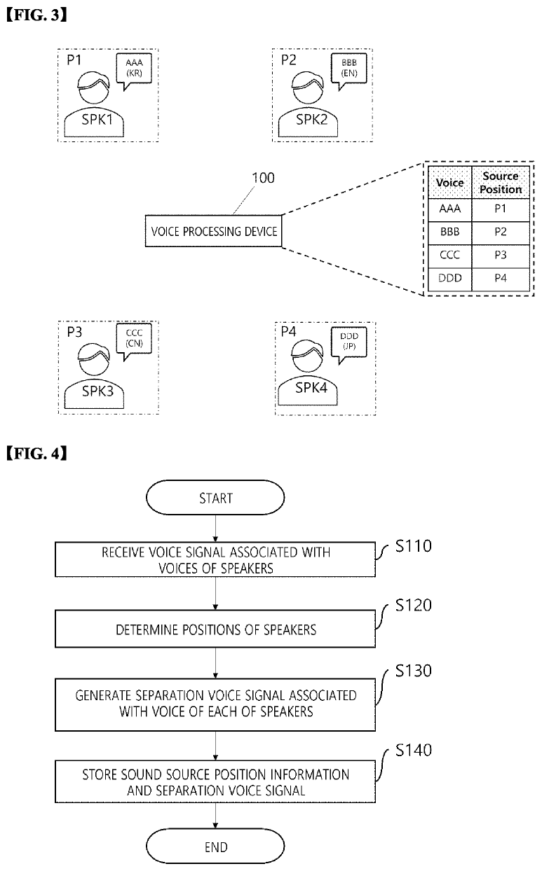

FIG. 3 is a view for describing an operation of the voice processing device according to the embodiments of the present disclosure. Hereinafter, the operation of the voice processing device 100 described in the present specification can be understood as the operation performed under the control of the processor 130 included in the voice processing device 100.

Referring to FIG. 3, each of the speakers SPK1 to SPK4 respectively positioned at the positions P1 to P4 may pronounce.

The voice processing device 100 according to the embodiments of the present disclosure may generate the separation voice signal associated with the voice of each of the speakers SPK1 to SPK4 from the voices of the speakers SPK1 to SPK4 and store the separation voice signal and the sound source, that is, the sound source position information representing the position of each of the speakers SPK1 to SPK4.

According to the embodiments, the voice processing device 100 may determine the sound source positions of the voices (i.e., the positions of the speakers SPK1 to SPK4) using the time delay (or the phase delay) between the voice signals. For example, the voice processing device 100 may determine relative positions of the sound sources (i.e., the speakers SPK1 to SPK4) with respect to the voice processing device 100.

The voice processing device 100 may generate the separation voice signal associated with the voice of each of the speakers SPK1 to SPK4 based on the determined sound source position.

As illustrated in FIG. 3, the first speaker SPK1 pronounces a voice “AAA,” the second speaker SPK2 pronounces a voice “BBB,” the third speaker SPK3 pronounces a voice “CCC,” and the fourth speaker SPK4 pronounces a voice “DDD.”

The voice processing device 100 may generate voice signals associated with the voices of the speakers SPK1 to SPK4 in response to the voices of the speakers SPK1 to SPK4. In this case, the generated voice signals include components associated with the voices “AAA,” “BBB,” “CCC,” and “DDD” of the speakers SPK1 to SPK4.

The voice processing device 100 may generate a first separation voice signal associated with the voice “AAA” of the first speaker SPK1, a second separation voice signal associated with the voice “BBB” of the second speaker SPK2, a third separation voice signal associated with the voice “CCC” of the third speaker SPK3, and a fourth separation voice signal associated with the voice “DDD” of the fourth speaker SPK4 using the generated voice signals.

In this case, the voice processing device 100 may store the separation voice signals associated with the voices of the speakers SPK1 to SPK4 and the sound source position information representing the positions (i.e., the sound source positions) of the speakers SPK1 to SPK4 in the memory 140. For example, the voice processing device 100 may store the first separation voice signal associated with the voice “AAA” and the first position information representing the first position P1, which is the sound source position of the voice of the first speaker SPK1, in the memory 140. For example, as illustrated in FIG. 3, each of the separation voice signals and the sound source position information may be stored by being matched.

In other words, the voice processing device 100 according to the embodiments of the present disclosure may generate the separation voice signal associated with the voice of each of the speakers SPK1 to SPK4 from the voices of the speakers SPK1 to SPK4 and store the separation voice signals and the position information representing the position of each of the speakers SPK1 to SPK4.

FIG. 4 is a flowchart illustrating a voice separation method performed by the voice processing device according to the embodiments of the present disclosure. An operating method of the voice processing device to be described with reference to FIG. 4 may be stored in a non-transitory storage medium and implemented by an application (e.g., a voice separation application) executable by a computing device. For example, the processor 130 may execute an application stored in the memory 140 and perform operations corresponding to commands instructing specific operations depending on the execution of the application.

Referring to FIG. 4, the voice processing device 100 may generate the voice signals associated with the voices of the speakers SPK1 to SPK4 (S110). According to the embodiments, the voice processing device 100 may convert the voice detected in space into the voice signal, which is an electrical signal.

The voice processing device 100 may determine the positions of the speakers SPK1 to SPK4 using the voice signals associated with the voices of the speakers SPK1 to SPK4 (S120). According to the embodiments, the voice processing device 100 may generate the sound source position information representing the sound source positions (i.e., the positions of the speakers SPK1 to SPK4) corresponding to the positions of the speakers SPK1 to SPK4.

The voice processing device 100 may generate the separation voice signal associated with each voice of the speakers SPK1 to SPK4 based on the sound source position for each of the voices (S130). According to the embodiments, the voice processing device 100 may generate the separation voice signal associated with each of the voices of the speakers SPK1 to SPK4 by separating the generated voice signal based on the sound source position for each of the voices. For example, the voice processing device 100 may generate the separation voice signal associated with each of the voices of the speakers SPK1 to SPK4 by separating components included in the voice signal based on the sound source position.

The voice processing device 100 may store the sound source position information representing the sound source position and the separation voice signal (S140). According to the embodiments, the voice processing device 100 may match the sound source position information representing the sound source position and the separation voice signal associated with the voice of each of the speakers SPK1 to SPK4 and store a result of the matching. For example, the voice processing device 100 may match data corresponding to the separation voice signal associated with the voice of each of the speakers SPK1 to SPK4 and the sound source position information and store a result of the matching.

According to the embodiments, the voice processing device 100 (or the processor 130) according to the embodiments of the present disclosure may generate (or separate) the separation voice signal associated with the voice of each of the speakers SPK1 to SPK4 from the voice signal associated with the voices of the speakers SPK1 to SPK4 by executing the application (e.g., the voice separation application) stored in the memory 140.

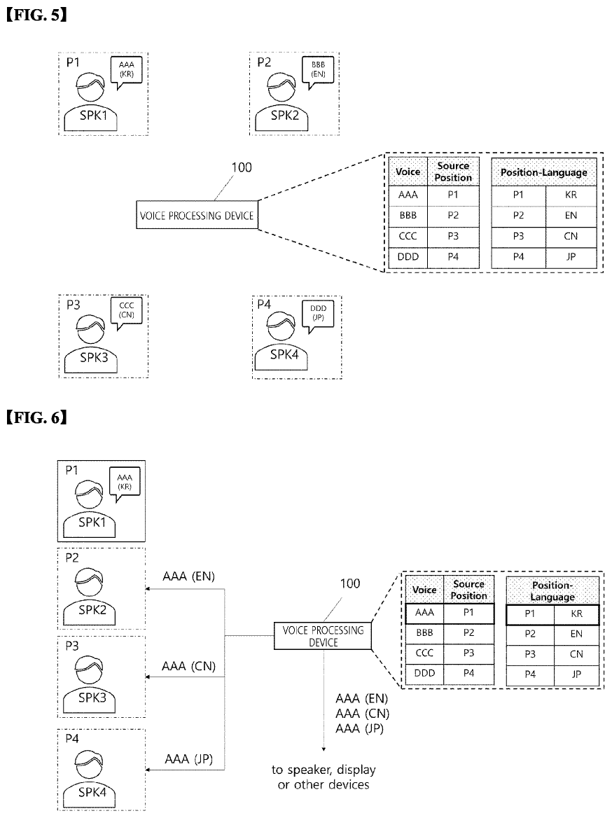

FIG. 5 is a view for describing a translation function of the voice processing device according to the embodiments of the present disclosure. Referring to FIG. 5, the first speaker SPK1 pronounces the voice “AAA” in Korean (KR), the second speaker SPK2 pronounces the voice “BBB” in English (EN), the third speaker SPK3 pronounces the voice “CCC” in Chinese (CN), and the fourth speaker SPK4 pronounces the voice “DDD” in Japanese (JP).

The voice processing device 100 according to the embodiments of the present disclosure may determine the position of each of the speakers SPK1 to SPK4 from the voices of the speakers SPK1 to SPK4 and generate the separation voice signal associated with the voice of each of the speakers SPK1 to SPK4. The voice processing device 100 may determine the languages of the voices of the speakers SPK1 to SPK4 using the position-language information stored in correspondence to the position of each of the speakers SPK1 to SPK4 and provide the translation for the voices of the speakers SPK1 to SPK4.

For example, the voice processing device 100 may store first position-language information representing that the language corresponding to the first position P1 is “KR” in the memory 140. In addition, the voice processing device 100 may store the first separation voice signal associated with the voice “AAA” of the first speaker SPK1, the first sound source position information representing the first position P1, which is the position of the first speaker SPK1, and the first position-language information representing Korean (KR), which is the language of the voice “AAA” of the first speaker SPK1, in the memory 140.

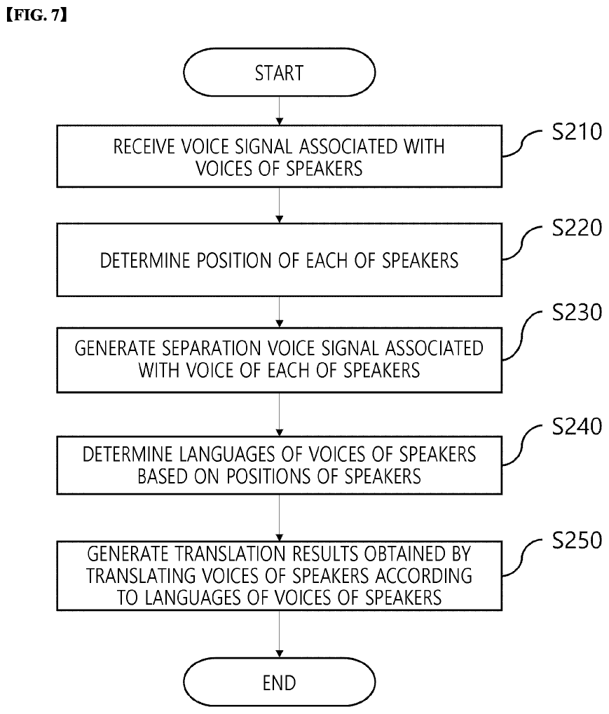

FIG. 6 is a view for describing a translation function of the voice processing device according to the embodiments of the present disclosure. Referring to FIG. 6, the voice processing device 100 may generate the separation voice signal associated with the voice of each of the speakers SPK1 to SPK4 and generate the translation result for the voice of each of the speakers SPK1 to SPK4 using the separation voice signals. In this case, the translation result is the result of converting the languages of the voices of the speakers SPK1 to SPK4 into different languages (e.g., the target languages).

For example, the voice processing device 100 may convert the separation voice signal into text data (e.g., speech-to-text (STT) conversion), generate a translation result for the converted text data, and convert (e.g., text-to-speech (TTS) conversion) the translation result into a voice signal. In other words, the translation results mentioned in the present specification may refer to both text data or voice signal associated with the voice of each of the speakers SPK1 to SPK4 expressed in the target languages.

According to the embodiments, the voice processing device 100 may output the generated translation results. For example, the voice processing device 100 may output the generated translation results through the speaker 150 or transmit the generated translation results to another external device.

As illustrated in FIG. 6, the first speaker SPK1 pronounces the voice “AAA” in Korean (KR). In this case, the source language of the voice “AAA” of the first speaker SPK1 is Korean (KR).

The voice processing device 100 may determine the sound source position (e.g., P1) of the first speaker SPK1 in response to the voice “AAA” of the first speaker SPK1 and generate the first separation voice signal associated with the voice “AAA” of the first speaker SPK1 based on the sound source position.

The voice processing device 100 may provide the translation for the voices of the speakers SPK1 to SPK4 using the generated separation voice signals. According to the embodiments, the voice processing device 100 may determine the languages of the voices pronounced by the speakers SPK1 to SPK4 respectively positioned at the positions P1 to P4 using the position-language information stored in the memory 140 and generate the translation result for the language of the voice of each of the speakers SPK1 to SPK4 according to the determined languages.

As illustrated in FIG. 6, the voice processing device 100 may read the first position-language information representing that the language of the voice “AAA” pronounced at the first position P1 is Korean (KR) from the memory 140 using the first sound source position information representing the first position P1, which is the sound source position of the voice “AAA” of the first speaker SPK1. The voice processing device 100 may generate the translation result obtained by translating Korean (KR), which is the language of the voice “AAA” of the first speaker SPK1, into different languages.

According to the embodiments, the voice processing device 100 may generate the translation result obtained by translating the language of the voice “AAA” into different languages using the separation voice signal for the voice “AAA” of the first speaker SPK1 and the information representing that the language of the voice “AAA” is Korean (KR).

In this case, the languages (i.e., the target languages) into which the voices of the speakers SPK1 to SPK4 are translated may be predetermined, specified by an external user's input, or set by the voice processing device 100.

According to the embodiments, the voice processing device 100 may generate the translation result translating a language of a voice of one speaker among the speakers SPK1 to SPK4 into languages of the remaining speakers based on the position-language information representing the languages corresponding to the positions of the speakers SPK1 to SPK4.

As illustrated in FIG. 6, the voice processing device 100 may determine that the languages (i.e., the target languages) into which the voice “AAA” of the first speaker SPK1 positioned at the first position P1 is translated is the languages (English, Chinese, and Japanese) corresponding to the position of the remaining speakers SPK2 to SPK4 except for the first speaker SPK1 based on the pre-stored position-language information. According to the determination, the voice processing device 100 may generate the translation result of translating the language of the voice “AAA” into English, Chinese, and Japanese.

In other words, in a situation in which the plurality of speakers SPK1 to SPK4 pronounce, the voice processing device 100 according to the embodiments of the present disclosure may determine the positions (i.e., the sound source positions) of the speakers SPK1 to SPK4 from the voices of the speakers SPK1 to SPK4, determine the languages (source languages and target languages) of the speakers SPK1 to SPK4 from the determined positions, and translate the voices of the speakers SPK1 to SPK4 based on the determined languages.

According to the embodiments, the voice processing device 100 may provide the translation results to the remaining speakers SPK2 to SPK4. In addition, according to the embodiments, the voice processing device 100 may transmit the translation results to other devices (e.g., a speaker, a display, or an external device).

FIG. 7 is a flowchart illustrating a method of generating the translation results by the voice processing device according to the embodiments of the present disclosure. An operating method of the voice processing device to be described with reference to FIG. 7 may be stored in a non-transitory storage medium and implemented by an application (e.g., a translation application) executable by a computing device. For example, the processor 130 may execute an application stored in the memory 140 and perform operations corresponding to commands instructing specific operations depending on the execution of the application.

Referring to FIG. 7, the voice processing device 100 may generate the voice signals associated with the voices of the speakers SPK1 to SPK4 (S210).

The voice processing device 100 may determine the positions of the speakers SPK1 to SPK4 using the voice signals associated with the voices of the speakers SPK1 to SPK4 (S220). According to the embodiments, the voice processing device 100 may generate the sound source position information representing the sound source positions (i.e., the positions of the speakers SPK1 to SPK4) corresponding to the positions of the speakers SPK1 to SPK4.

The voice processing device 100 may generate the separation voice signal associated with each voice of the speakers SPK1 to SPK4 based on the sound source position for each of the voices (S230).

The voice processing device 100 may determine the languages (i.e., the current languages) of the voices of the speakers SPK1 to SPK4 based on the positions of the speakers SPK1 to SPK (S240). According to the embodiments, the voice processing device 100 may determine the language (i.e., the current language) of each of the speakers SPK1 to SPK4 using the determined sound source information and the stored position-language information (S240).

The voice processing device 100 may generate the translation result for the voice of each of the speakers SPK1 to SPK4 according to the determined language of the voice (S250). According to the embodiments, the voice processing device 100 may generate the translation result for the voice of each of the speakers SPK1 to SPK4 using the separation voice signal of each of the speakers SPK1 to SPK4 and the information about the languages of the voices of the speakers SPK1 to SPK4.

For example, the voice processing device 100 may generate the translation result translating the language of the voice of one speaker among the speakers SPK1 to SPK4 into the languages of the remaining speakers based on the position-language information representing the languages corresponding to the positions of the speakers SPK1 to SPK4.

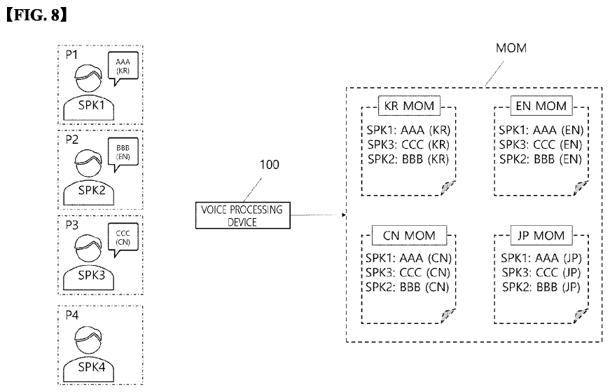

FIG. 8 is a view for describing an operation of the voice processing device according to the embodiments of the present disclosure. Referring to FIG. 8, the voice processing device 100 may generate a minutes of meeting (MOM) using the separation voice signal associated with the voice of each of the speakers SPK1 to SPK4.

The MOM may be data in which the pronounced content of each of the speakers SPK1 to SPK4 is recorded. For example, the pronounced content of each of the speakers SPK1 to SPK4 may be configured by being organized in a chronological order.

The voice processing device 100 may generate the MOM and store (or record) the pronounced contents of the speakers SPK1 to SPK4 in the MOM using the separation voice signals associated with the voices of the speakers SPK1 to SPK4. In this case, the voice processing device 100 may match the pronounced content of each of the speakers SPK1 to SPK4 with an identifier (e.g., a name) for identifying each of the speakers SPK1 to SPK4 and record a result of the matching. Therefore, it is possible to confirm which speaker has pronounced what content through the MOM.

According to the embodiments, the MOM may consist of at least one of text data, voice data, or image data, but is not limited thereto. The voice processing device 100 may generate the MOM by processing the separation voice signals associated with the voices of the speakers SPK1 to SPK4. For example, the voice processing device 100 may generate the separation voice signal associated with the voice of each of the speakers SPK1 to SPK4 in response to the voices of the speakers SPK1 to SPK4 and generate the MOM by converting the generated separation voice signal into texts and storing the texts.

The voice processing device 100 according to the embodiments of the present disclosure may generate not only the MOM (i.e., original MOM) including the content of the voice of each of the speakers SPK1 to SPK4 expressed in the original language (i.e., the source language), but also a MOM (i.e., a translated MOM) including the content of the voices of each of the speakers SPK1 to SPK4 expressed in different languages (i.e., target languages). For example, since the first speaker SPK1 pronounces in Korean (KR), from the first speaker SPK1 perspective, Korean MOM (KR MOM) becomes the original MOM, and English MOM (EN MOM), Chinese MOM (CN MOM), and Japanese MOM (JP MOM) become translated MOM.

According to the embodiments, the voice processing device 100 may generate the original MOM using the separation voice signal for the voice of each of the speakers SPK1 to SPK4 and generate the translated MOM translated into the language of the voice of each of the speakers SPK1 to SPK4 using the translation result for the separation voice signal.

According to the embodiments, the voice processing device 100 may record the KR MOM in which the voice contents of the speakers SPK1 to SPK4 are expressed in Korean (KR), which is the language of the first speaker SPK1 among the speakers SPK1 to SPK4. For example, the voice processing device 100 may generate the KR MOM using the first separation voice signal (i.e., expressed in Korean (KR)) associated with the voice of the first speaker SPK1 among the speakers SPK1 to SPK4 and the translation results of translating the languages of the voices of the remaining speakers SPK2 to SPK4 into Korean (KR), which is the language of the first speaker SPK1. Likewise, the voice processing device 100 may generate the MOM (EN MOM, CN MOM, and JP MOM) in which the contents of the voices of the speakers SPK1 to SPK4 are expressed in the languages of the remaining speakers SPK2 to SPK4.

As illustrated in FIG. 8, the first speaker SPK1 at the first position P1 pronounces the voice “AAA” in Korean, the third speaker SPK3 at the third position P3 pronounces the voice “CCC” in Chinese, and the second speaker SPK2 at the second position P2 pronounces the voice “BBB” in English.

The voice processing device 100 determines the first position P1, which is the sound source position of the voice “AAA” and generates the first separation voice signal associated with the voice “AAA” in response to the voice “AAA.” The voice processing device 100 may determine that the language (i.e., the source language) of the voice “AAA” is Korean (KR) based on the position-language information.

The voice processing device 100 may generate the KR MOM using the first separation voice signal for the voice “AAA.” For example, the voice processing device 100 may generate the KR MOM and record (or store) the text data corresponding to the first separation voice signal for the voice “AAA” in the KR MOM. In other words, the KR MOM may include the content about the voice “AAA” pronounced in Korean (KR).

The voice processing device 100 may generate the EN MOM, the CN MOM, and the JP MOM using the translation result for the voice “AAA.” For example, the voice processing device 100 may generate the EN MOM, convert the translation result of translating the language of the voice “AAA” into English (EN) into texts, and record (or store) the text data in the EN MOM. In other words, the EN MOM may include the content about the voice “AAA” described in English (EN).

Likewise, the voice processing device 100 may record the content of the voice “CCC” pronounced in Chinese (CN) in the CN MOM using the third separation voice signal for the voice “CCC” and record the content of the voice “CCC” pronounced in different languages in the MOM of different languages (KR MOM, EN MOM, and JP MOM) using the translation result for the voice “CCC.”

Likewise, the voice processing device 100 may record the content of the voice “BBB” pronounced in English (EN) in the EN MOM using the second separation voice signal for the voice “BBB” and record the content of the voice “BBB” pronounced in different languages in the MOM of different languages (KR MOM, CN MOM, and JP MOM) using the translation result for the voice “BBB.”

As described above, although the embodiments were described with reference to limited examples and drawings, various modifications and changes can be made by those skilled in the art from the above description. For example, although the described techniques may be performed in a different order from the described method and/or components of the described system, structure, apparatus, circuit, and the like may be coupled or combined in a different form from the described method or replaced with or substituted with other components or equivalents, appropriate results can be achieved.

Therefore, other implementations, other embodiments, and equivalents of the claims also fall within the scope of the claims to be described below.

### INDUSTRIAL APPLICABILITY

Embodiments of the present disclosure relate to a device and a method for processing voices of speakers.

1. A voice processing device configured to generate translation results for voices of speakers, comprising:
a microphone configured to generate voice signals associated with the voices of the speakers in response to the voices of the speakers;
a memory configured to store position-language information representing languages corresponding to sound source positions of the voices of the speakers; and
a processor configured to generate translation results obtained by translating the language of the voice of each of the speakers using the voice signal and the position-language information and generate translated minutes of meeting including a voice content of each of the speakers expressed in different languages using the translation results.

2. The voice processing device of claim 1, wherein the processor is configured to:
determine the sound source positions of the voices of the speakers using the voice signals generated from the microphone and generate sound source position information representing the determined sound source positions;
generate a separation voice signal associated with the voice pronounced at each sound source position from the voice signal;
determine current languages of the voices of the speakers using the position-language information stored in the memory; and
generate the translation results obtained by translating the current languages of the voices of the speakers into the different languages using the separation voice signal and the determined current languages.

3. The voice processing device of claim 1, wherein the processor is configured to:
determine the sound source positions of the voices of the speakers using the voice signals generated from the microphone and generate sound source position information representing the determined sound source positions;
generate a separation voice signal associated with the voice pronounced at each sound source position from the voice signal;
determine current languages of the voices of the speakers using the position-language information stored in the memory; and
generate the translation results obtained by translating the current languages of the voices of the speakers into the different languages using the separation voice signal and the determined current languages.

4. The voice processing device of claim 2, wherein the processor is configured to:
determine different languages into which the current language of the voice of each of the speakers is translated using the position-language information stored in the memory; and
generate a translation result obtained by translating the current language of the voice of the speaker into different languages according to the determined current language and different languages.

5. The voice processing device of claim 4, wherein the processor is configured to:
generate first sound source position information representing a sound source position of a voice of a first speaker among the speakers using the voice signals associated with the voices of the speakers;
generate a first separation voice signal associated with the voice of the first speaker using the voice signals and the first sound source position information;
determine a language of the voice of the first speaker corresponding to the first sound source position information with reference to the position-language information stored in the memory;
determine languages of the voices of the remaining speakers except for the first speaker among the speakers with reference to the position-language information stored in the memory; and
generate translation results obtained by translating the language of the voice of the first speaker into the languages of the voices of the remaining speakers using the first separation voice signal.

6. The voice processing device of claim 2, wherein the processor generates original minutes of meeting including a voice content of each of the speakers expressed in the current languages of the voices of the speakers using the separation voice signal.

7. The voice processing device of claim 1, wherein the processor generates the translated minutes of meeting, converts the translation results into texts, and records text data in the translated minutes of meeting.

8. A voice processing method using a voice processing device configured to generate translation results for voices of speakers, comprising:
storing position-language information representing languages corresponding to sound source positions of the voices of the speakers;
generating voice signals associated with the voices of the speakers using a microphone;
generating translation results obtained by translating a language of a voice of each of the speakers using the voice signal and position-language information; and
generating translated minutes of meeting including a voice content of each of the speakers expressed in different languages using the translation results.

9. The voice processing method of claim 8, wherein the generating of the translation results includes:
determining sound source positions of the voices of the speakers using the generated voice signals;
generating sound source position information representing the determined sound source position;
generating a separation voice signal associated with the voice pronounced at each sound source position from the voice signal;
determining current languages of the voices of the speakers using the stored position-language information; and
generating the translation results obtained by translating the current languages of the voices of the speakers into the different languages using the separation voice signal and the determined current languages.

10. The voice processing method of claim 9, wherein the microphone includes a plurality of microphones disposed to form an array, and
the determining of the sound source positions of the speakers includes determining the sound source position based on a time delay between a plurality of voice signals generated from the plurality of microphones.

11. The voice processing method of claim 9, wherein the generating of the translation results further includes:
determining different languages into which the current language of the voice of each of the speakers is translated using the stored position-language information; and
generating a translation result obtained by translating the current languages of the voices of the speakers into different languages according to the determined current languages and different languages.

12. The voice processing method of claim 11, wherein the generating of the translation results further includes:
generating first sound source position information representing a sound source position of a voice of a first speaker among the speakers using the voice signals associated with the voices of the speakers;
generating a first separation voice signal associated with the voice of the first speaker using the voice signals and the first sound source position information;
determining a language of the voice of the first speaker corresponding to the first sound source position information with reference to the stored position-language information;
determining languages of the voices of the remaining speakers except for the first speaker among the speakers with reference to the stored position-language information; and
generating translation results obtained by translating the language of the voice of the first speaker into the languages of the voices of the remaining speakers using the first separation voice signal.

13. The voice processing method of claim 9, further comprising generating original minutes of meeting including a voice content of each of the speakers expressed in the current languages of the voices of the speakers using the separation voice signal.

14. The voice processing method of claim 8, further comprising converting the translation result into texts and recording text data in the translated minutes of meeting.
